(19) United States
(12) Patent Application Publication
(10) Pub. No.: US 2024/0356003 A1
(43) Pub. Date: Oct. 24, 2024

(54) ELECTRODE SLURRY, ELECTRODE, AND ELECTROCHEMICAL CELL INCLUDING SAME

(71) Applicant: UBATT INC., Seoul (KR)

(72) Inventors: Keun Ho Choi, Daejeon (KR); Jung Hwan Kim, Daejeon (KR); Geon Hee Lee, Daejeon (KR); Hyeong Min Jo, Daejeon (KR); Chang Hyeon Kim, Gongju-si, Chungcheongnam-do (KR); Chang Kyoo Lee, Seoul (KR)

(21) Appl. No.: 18/685,444

(22) PCT Filed: Dec. 7, 2022
(86) PCT No.: PCT/KR2022/019783

§ 371 Date: Feb. 21, 2024

(30) Foreign Application Priority Data
Dec. 10, 2021 (KR) 10-2021-0176966

(51) Int. Cl. H01M 4/13; H01M 4/02; H01M 4/62; H01M 10/42

(52) U.S. Cl. CPC H01M 4/13; H01M 4/623; H01M 4/625; H01M 10/4235; H01M 2004/021; H01M 2004/027; H01M 2004/028

(57) ABSTRACT

The present invention relates to a slurry for fabricating an electrode, an electrode, and an electrochemical cell including same. The slurry for fabricating an electrode according to the present invention includes: an electrode material; an organic binder; and two or more solvents having different solubility parameters. The electrode fabricated using the slurry for fabricating an electrode according to the present invention may have a structure in which electrode materials are dispersed and bound to a porous matrix in a network configuration.

### TECHNICAL FIELD

The present disclosure relates to an electrode slurry, an electrode, and an electrochemical cell including same.

### BACKGROUND ART

In order to develop a high-power, high-capacity battery, a new electrode material, such as a silicon-based material or a selenium-based material, metal lithium, and the like, which may replace graphite, has been researched continuously.

With the development of this material, technologies for high-density/high-loading of an electrode itself are also being studied, but as an electrode active material layer becomes thicker, it may be difficult to ensure both stable electrical conduction characteristics and ion conduction characteristics, in reality, there is a limit to the increase in thickness, and the development of new materials is a main focus of research.

### SUMMARY OF INVENTION

### Technical Tasks

An aspect of the present disclosure is to provide an electrode having excellent electrochemical properties, an electrode slurry for fabricating the electrode, and an electrochemical cell including the same.

Another aspect of the present disclosure is to provide an electrode in which degradation of electrochemical properties is suppressed even during thick film formation, an electrode slurry for fabricating the electrode, and an electrochemical cell including the same.

Another aspect of the present disclosure is to provide an electrode capable of increasing a fraction of an electrode material by requiring a small amount of a material such as a binder or a conductive material other than an electrode material, an electrode slurry capable of manufacturing the electrode, and an electrochemical cell including the same.

### Technical Solution

An electrode slurry according to the present disclosure may include: an electrode material; an organic binder; and a mixed solvent including two or more solvents having different solubility parameters.

In an embodiment, the two or more solvents may have different boiling points.

In an embodiment, the slurry may further include a conductive material.

In an embodiment, the slurry may further include salt.

In an embodiment, the mixed solvent may include the two or more solvents having a solubility parameter difference of 0.1 to 20.

In an embodiment, one of the two or more solvents may have a solubility parameter of 15 to 30 MPa^{0.5}.

In an embodiment, a solvent having a smaller solubility parameter may be referred to as a first solvent and a solvent having a higher solubility parameter may be referred to as a second solvent, and a weight ratio of the first solvent to the second solvent may be 1:0.1 to 10.

In an embodiment, a difference in boiling points of the two or more solvents may be 1 to 200° C.

In an embodiment, the slurry may satisfy one or more of the following conditions 1 to 4:
1) 0.01 to 30 parts by weight of the organic binder based on 100 parts by weight of the electrode material;
2) 10 to 300 parts by weight of the mixed solvent based on 100 parts by weight of the electrode material;
3) the slurry further including a conductive material, and 0.01 to 30 parts by weight of the conductive material based on 100 parts by weight of the electrode material; and
the slurry further including salt, and 0.01 to 50 parts by weight of salt based on 100 parts by weight of the electrode material.

In an embodiment, the conductive material is a carbon-based conductive material.

In an embodiment, the salt may include a metal salt, an ionic liquid, an ionomer, or a mixture thereof.

In an embodiment, the metal salt may include a sulfonyl group.

In an embodiment, the metal salt may be at least one selected from compounds satisfying the following formulas 1 to 4.

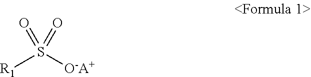

In formula 1, A⁺ is a monovalent cation, and R₁ is F, CFH₂, CF₂H, or CnF₂ₙ₊₁ (where n is a natural number of 1 or more).

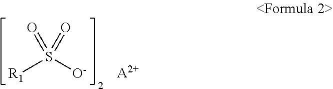

In Formula 2, A²⁺ is a divalent cation, and R₁ is F, CFH₂, CF₂H, or CnF₂ₙ₊₁ (where n is a natural number of 1 or more).

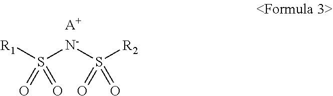

In Formula 3, A⁺ is a monovalent cation, R₁ and R₂ are independent of each other, and are F, CFH₂, CF₂H, or CnF₂ₙ₊₁ (where n is a natural number of 1 or more).

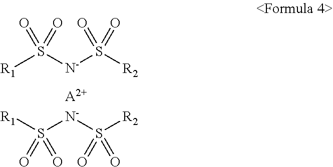

In Formula 4, A²⁺ is a divalent cation, R₁ and R₂ are independent of each other, and are F, CFH₂, CF₂H, or CnF₂ₙ₊₁ (where n is a natural number of 1 or more).

In an embodiment, an electrode slurry may include: an electrode material; an organic binder; a solvent; and a pore former.

In an embodiment, the electrode slurry may be for an electrochemical cell.

The present disclosure may include an electrode fabricated using the above-described electrode slurry.

An electrode according to the present disclosure may include: a current collector; an electrode layer disposed on at least one surface of the current collector, wherein the electrode layer may include: a network configuration including at least an organic binder; and an electrode material dispersed in the network configuration.

In an embodiment, the electrode layer may further include a conductive material.

In an embodiment, the electrode layer may include a carbon-based conductive material.

In an embodiment, the conductive material may be complexed with the organic binder to form the network configuration.

In an embodiment, a specific surface area of the network configuration may be 0.1 m²/g to 1,000 m²/g.

In an embodiment, the electrode layer may contain 0.01 to 40 parts by weight of the network configuration based on 100 parts by weight of the electrode material.

In an embodiment, the electrode layer may contain 1 to 5 parts by weight of the network configuration based on 100 parts by weight of the electrode material.

In an embodiment, the network configuration may have an electrical conductivity of 0.01 S/cm to 1,000 S/cm.

In an embodiment, the electrode may further contain salt.

In an embodiment, the salt may be contained in or surface-adsorbed on at least one of the network configuration and the electrode material.

In an embodiment, the conductive material may be included in an amount of 10 to 300 parts by weight based on 100 parts by weight of the organic binder.

In an embodiment, an electrode may satisfy Equation 1 below,

$$0.3 \leq C 5 / C 0.1 \qquad < Equation 1 >$$

In Equation 1, C0.1 is the discharge capacity at 0.1C, and C5 is the discharge capacity at 5C.

In an embodiment, C5/C0.1 may be 0.6 or more.

An electrode according to the present disclosure may include: a current collector; and an electrode layer disclosed on at least one surface of the current collector and containing an electrode material, wherein the electrode may satisfy Equation 2 below.

$${η}_{a c t \& c o n c} / {η}_{o h m i c} \leq 0.8 \qquad < Equation 2 >$$

In Equation 2, η_{ohmic} is ohmic polarization at 5C, and η_{act&conc} is the sum of activation polarization and concentration polarization at 5C.

In an embodiment, η_{act&conc}, which is the sum of the activation polarization and the concentration polarization at 5C, may be 90 mV or less.

In an embodiment, the electrode material may be a positive electrode material or a negative electrode material.

In an embodiment, the electrode material may include a metal, metal-nonmetal composite, a metalloid, a metalloid-nonmetal composite, or a metalloid-metal composite, a metalloid-metal-nonmetal composite, or a mixture thereof.

In an embodiment, an electrode may include: a current collector; and an electrode layer disposed on at least one surface of the current collector, wherein the electrode layer may include a network configuration containing an organic binder and a conductive material and an electrode material dispersed in the network configuration, and the electrode layer may have a thick film type with a thickness of 50 to 3000 μm.

In an embodiment, an electrode may include: a current collector; and an electrode layer disposed on the current collector, wherein the electrode layer may include a network configuration containing an organic binder, an electrode material, and a solid electrolyte.

The present disclosure may include an electrochemical cell including the above-described electrode.

The present disclosure may include an electrochemical module including the above-described electrochemical cell.

The present disclosure may include a device configured to receive power from the above-described electrochemical cell.

### Advantageous Effects of Invention

An electrode according to the present disclosure may ensure electrical conductivity and mechanical properties of the electrode with a small amount of a binder and a conductive material, due to a network configuration filling a space between electrode materials and including the binder, thereby having excellent high rate characteristics due to excellent ion conductivity and low active polarization, and suppressing degradation of the electrochemical properties of the electrode even during thick film formation.

### BRIEF DESCRIPTION OF DRAWINGS

FIG. 1 is a scanning electron micrograph image obtained by observing a structure of a positive electrode fabricated in Comparative Example 1.

FIG. 2 is a scanning electron micrograph image of a structure of a positive electrode fabricated in Inventive Example 2.

FIG. 3 is a view illustrating peel strength of a positive electrode active material layer fabricated in Inventive Example 2 and Comparative Example 1.

FIG. 4 is a view illustrating results of measuring a discharge capacity retention rate according to a C-rate of a battery fabricated in Inventive Example 2 and Comparative Example 1.

FIG. 5 is a view illustrating discharge characteristics for each C-rate of a positive electrode fabricated in Inventive Example 2 and Comparative Example 1.

### BEST MODE FOR INVENTION

Hereinafter, an electrode slurry, an electrode, and an electrochemical cell of the present disclosure will be described in detail with reference to the accompanying drawings. The drawings presented hereinafter are provided as examples to sufficiently transmit the technical concept of the present disclosure to those skilled in the art. Thus, the present disclosure is not limited to the drawings presented hereinafter and may be embodied in a different form, and the drawings present hereinafter may be exaggerated to be illustrated to clarify the technical concept of the present invention. Here, technical terms and scientific terms have the same meaning as generally understood by person skilled in the art to which the present disclosure pertains, unless otherwise defined, and a detailed description for a related known function or configuration considered to unnecessarily divert the gist of the present invention will be omitted in the following descriptions and accompanying drawings.

In addition, the singular form used in the specification and claims appended thereto may be intended to also include a plural form, unless otherwise indicated in the context.

In this specification and the appended claims, the terms first, second, etc., should not be limited by these terms, and these terms are only used to distinguish one component from another component.

The terms such as “comprises,” “comprising,” “includes,” “including,” “has” and/or “having,” when used herein, specify the presence of stated features, components and/or combinations thereof, but do not preclude the presence or addition of one or more other features and/or components, unless otherwise specified.

In this specification and the appended claims, when a film (layer), region, or component is above or on another portion, the film (layer), region, or a component may be in contact with another portion and disposed directly thereon, or an intervening film (layer), region, or component may exist.

The present applicant recognized that ion transfer resistance and uneven distribution (aggregation) of a binder, which increase upon thick film formation of an electrode, are the main factors that degrade electrode characteristics, and conducted various studies over a long period of time to develop an electrode structure that may reduce ion transfer resistance and binder aggregation while minimizing a decrease in electrode density. As a result, by implementing micropores in the electrode, specifically the binder component, away from the technical common sense known in a the present applicant has developed an battery field, electrode in which electrochemical properties hardly deteriorate even during thick film formation, and a binder is dispersed extremely uniformly, and developed a technique in which a binder component is complexed with a conductive material component and microporous to ensure electrical properties of an electrode as well, thereby completing the present disclosure.

An electrode slurry according to an aspect of the present disclosure based on the above-described research and development includes an electrode material; an organic binder; and a mixed solvent including two or more solvents having different solubility parameters. The solubility parameter may be a Hansen solubility parameter (MPa^{0.5}).

As the electrode slurry includes two or more solvents having different solubility parameters, when the electrode slurry is applied and dried, the organic binder may be porous.

Specifically, when two or more types of solvent having different solubility parameters are referred to as a first solvent and a second solvent, the first solvent and the second solvent may have different solubility with respect to the organic binder according to different solubility parameters. Due to different solubility between solvents, solidification of the organic binder may occur in a state in which the solvent remains during a drying process of the electrode slurry, porousization of the binder component may occur in the electrode by volatilization of a residual solvent in the binder during and/or after solidification of the organic binder.

In other words, one of the first solvent and the second solvent having different solubility parameters may serve as a pore forming agent for implementing porosity in the binder. Thus, an electrode slurry according to another aspect of the present disclosure may include an electrode material; an organic binder; a solvent; and a pore forming agent. In this case, the solvent may be a good solvent of the organic binder, and the pore forming agent may be a heterogeneous solvent having a solubility parameter different from that of the solvent. Hereinafter, unless particularly limited, the pore forming agent may correspond to any one of two or more solvents to be described below.

In an embodiment, two or more solvents having different solubility parameters may mean that in at least one component selected from a dispersion component δₚ (MPa^{0.5}), a dipole component δ_{d} (MPa^{0.5}) and a hydrogen bonding component δₕ (MPa^{0.5}) of the Hansen solubility parameter, a difference in component values is 1 or more, 2 or more, 3 or more, 4 or more, 5 or more, 6 or more, 7 or more, 8 or more, or 9 or more, and a difference in component values is 15 or less, 13 or less, 12 or less, 11 or less, or 10 or less.

In order ensure stable miscibility between two or more types of solvent and to have different dissolution properties with respect to the organic binder, a difference in solubility parameters between two or more types of solvent may be 0.1 or more to 20 or less, specifically, 0.5 or more, 1 or more, 2 or more, 3 or more, or 4 or more, and may be 15 or less, 10 or less, 9 or less, 8 or less, 7 or less, 6 or less, or 5 or less. Preferably, two or more solvents may satisfy the difference between the above-described components together with the difference in solubility parameters. More preferably, a difference in component values between at least two solvents with respect to at least one component selected from a dispersion force component δₚ (MPa^{0.5}), a dipole component δ_{d} (MPa^{0.5}) and a hydrogen bonding component δₕ (MPa^{0.5}), specifically, the dipole component and/or the hydrogen bonding component, may be 1 or more, 2 or more, 3 or more, 4 or more, 5 or more, 6 or more, 7 or more, 8 or more or 9 or more, and may be 15 or less, 13 or less, 12 or less, 11 or less, or 10 or less, and a difference in component values between two or more types of solvent with respect to another component, specifically a dispersion component, may be 4 or less, 3 or less, 2 or less or 1 or less, and may be 0 or more or 0.5 or more. Two or more types of solvent which satisfies the above-described difference in solubility parameter, has a large difference in component values of each component of the dipole component, the hydrogen bonding component, or the dipole component and the hydrogen bonding component, and has a significantly small difference in component values between the dipole component and the dispersion force component may ensure a significantly large solubility difference in organic binders between solvents, so that one solvent may perform the role of the pore forming agent very effectively.

In an advantageous embodiment, two or more types of solvent (first solvent and second solvent) may have different boiling points, and among the two or more types of solvent, a boiling point of one solvent that is a good solvent with respect to the organic binder may be relatively lower than that of the other solvents. That is, when the good solvent of the organic binder is referred to as the first solvent, a boiling point of the second solvent having relatively lower solubility in the organic binder than that of the first solvent may be higher than that of the first solvent. A difference in boiling points between two or more solvents based on atmospheric pressure (1 atm) may be 1 to 200° C. Specifically, the difference in boiling point between two or more solvents may be 10° C. or more, 15° C. or more, 20° C. or more, 25° C. or more, 30° C. or more, 35° C. or more, or 40° C. or more, and may be substantially 150° C. or less, 100° C. or less, 80° C. or less, or 60° C. or less. Due to the difference in boiling points, preferential volatilization removal of a solvent (good solvent) having a low boiling point may occur when the electrode slurry is dried, and in a state where all good solvents are substantially volatilized and removed, a solvent (a solvent having a high boiling point, i.e., a bad solvent) that may slightly dissolve the organic binder may remain. The difference in boiling points between two or more types of solvent may be 30° C. or higher, and in this case, a larger amount of the second solvent may remain in a state in which the first solvent is volatilized and removed by simple heating performed at a temperature lower than the boiling point of each of two or more types of solvent, which may be advantageous.

In an embodiment, a relative amount between two or more types of solvent having different solubility parameters may be controlled to control the degree of porosity of the binder. A solvent having a smaller solubility parameter may be referred to as a first solvent, and a solvent having a higher solubility parameter may be referred to as a second solvent, and a weight ratio of the first solvent: the second solvent may be 1:0.1 to 10, 1:0.1 to 5, 1:0.1 to 1, or 1:0.1 to 0.5, but the present disclosure is not necessarily limited thereto.

In a specific embodiment, among the two or more types of solvent, one solvent (e.g., the first solvent) may have a solubility parameter similar to that of the organic binder, and may have a dispersion component value, a dipole component value, and a hydrogen bonding component value similar thereto. In detail, a difference in solubility parameters between one solvent (e.g., the first solvent) serving as a good solvent of the organic binder and the organic binder may be 5 or less, 4 or less, 3 or less, 2 or less, or 1 or less, and may be substantially the same (0 or more) or may be 0.5 or more. In addition, a difference between the dispersion component values between one solvent (e.g., the first solvent) and the organic binder may be 3 or less, 2 or less, or 1 or less, and may be 0 or more, a difference between the dipole component values may be 3 or less, 2 or less, or 1 or less, and may be 0 or more, and a difference between the hydrogen bonding component values may be 4 or less, 3 or less, or 2 or less, and may be 0 or more.

As described above, as the one solvent (e.g., the first solvent) acting as a good solvent may have similar solubility parameters by a dispersion component value, a dipole component value, and a hydrogen bonding component value similar to the organic binder, a difference between the solubility parameter and the component value between the one solvent (e.g., the first solvent) and the other solvent (e.g., the second solvent) described above may be applied substantially as a difference between the solubility parameter and the component value between the organic binder and another solvent.

In other words, a difference in solubility parameters between a bad solvent (e.g., the second solvent) as a pore forming agent and the organic binder may be 0.1 or more to 20 or less, specifically 0.5 or more, 1 or more, 2 or more, 3 or more, or 4 or more, and may be 15 or less, 10 or less, 9 or less, 8 or less, 7 or less, 6 or less, or 5 or less. Furthermore, a difference in component values for at least one component selected from a dispersion component δₚ (MPa^{0.5}), a dipole component δ_{d} (MPa^{0.5}) and a hydrogen bonding component δₕ (MPa^{0.5}) of a bad solvent and an organic binder, specifically, the dipole component and/or the hydrogen bonding component, may be 1 or more, 2 or more, 3 or more, 4 or more, 5 or more, 6 or more, 7 or more, 8 or more, 9 or more, and may be 15 or less, 13 or less, 12 or less, 11 or less, or 10 or less, and a difference in component values for the other one component, specifically the dispersion component, may be 4 or less, 3 or less, 2 or less, or 1 or less, and may be 0 or more, or 0.5 or more.

When considering organic binders generally used for binding an electrode material in the field of an electrode or an electrochemical cell, a solubility parameter of any one of two or more solvents may be 15 to 30 MPa^{0.5}, 20 to 30 MPa^{0.5}, or 22 to 28 MPa^{0.5}, but the present disclosure is not limited by the specific solubility parameter value of the solvent.

The Hansen solubility parameter (based on 25° C.) of the specific solvent and the organic binder may be based on a value known through the Hansen solubility parameter (e.g., Charles Hansen, “Hansen Solubility Parameters: A User's Handbook” CRC Press (2007), “The CRC Handbook and Solubility Parameters and Cohesion Parameters,” Alan F. M. Barton (1999), etc.) published for each material or a value calculated by commercial software, such as Molecular Modeling Pro, Dynacomp Software, or the like, and the Hansen solubility parameter for each material is a value known to those skilled in the art or may be easily calculated thereby.

By the electrode slurry described above, an electrode layer including at least a network configuration containing an organic binder and an electrode material dispersed in the network configuration may be fabricated.

In an embodiment, when the electrode material is insulating or has low electrical conductivity, the electrode slurry may further include a conductive material. The conductive material may be a conductive material commonly used to improve the electrical properties of an electrode in the field of an electrode or an electrochemical cell.

However, in an advantageous embodiment, the conductive material may be e a carbon-based conductive material. The carbon-based conductive material may be advantageous in forming a network configuration together with an organic binder. When the carbon-based conductive material forms the network configuration together with the organic binder, the network configuration itself may have conductivity. The network configuration having conductivity may be advantageous in ensuring the electrical conductivity of the electrode when the electrical properties of the electrode material deteriorate.

The carbon-based conductive material may include a point-type carbon-based conductive material, a linear carbon-based conductive material, a plate-type carbon-based conductive material, or a mixture thereof. Examples of the point-type carbon-based conductive material may include acetylene black, ketjen black, channel black, furnace black, lamp black, thermal black, and carbon black, examples of the linear carbon-based conductive material may include carbon nanotubes and conductive carbon fibers, and examples of the plate-shaped carbon-based conductive material may include graphene (including GRO).

In an embodiment, the electrode slurry may further include salt. The salt does not adversely affect the electrochemical properties of the electrode and is sufficient as long as the salt may be dissociated in a mixed solvent in the electrode slurry. With the help of the salt, the carbon-based conductive material may be homogeneously complexed with the organic binder to form a porous network configuration. The salt may include a metal salt, an ionic liquid, an ionomer, or a mixture thereof. In the metal salt, at least one metal ion selected from the group consisting of alkali metal, alkaline earth metal and transition metal may be salt having cations, and at least ion selected from Cl⁻, Br⁻, I⁻. NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, AsF₆⁻, BF₆⁻, SbF₆⁻, (CF₃)₆P⁻, CF₃SO₃⁻, CF₃CF₂SO₃⁻, AlO₃⁻, AlCl₄⁻, C₄F₉SO(CF₃SO₂)₂N⁻, (CF₃CF₂SO₂)₂N⁻, (FSO₂)₂N⁻, (C₂F₅SO₃)₂N⁻, (F₃CF₂SO₂)₂N⁻(C₂F₅SO₂)₂N⁻, (CF₃SO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, B₁₀Cl₁₀⁻, C₄BO₈⁻, B(C₂O₄)₂⁻, and CH₃SO₃⁻ may be salt having anions.

The ionic liquid may include cations selected from the group consisting of imidazolium, ammonium, pyridinium, pyrazolium, piperidinium, triazolium, thiazolium, oxazolium, pyridazinium, pyrimidine, pyrazinium, phosphonium, pyrrolidinium and sulfonium, and anions selected from the group consisting of BF₄⁻, ClO₄⁻, PF₆⁻, (CF₃)₂PF₄⁻, (CF₃)₃PF₃⁻, (CF₃)₄PF₂⁻, (CF₃)₅PF⁻, AsF₆⁻, BF₆⁻, SbF₆⁻, (CF₃)₆P⁻, CF₃SO₃⁻, CF₃CF₂SO₃⁻, AlO₃⁻, AlCl₄⁻, C₄F₉SO(CF₃SO₂)₂N⁻, (CF₃CF₂SO₂)₂N⁻, (FSO₂)₂N⁻, (C₂F₅SO₃)₂N⁻, (F₃CF₂SO₂)₂N⁻(C₂F₃SO₂)₂N⁻, (CF₃SO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻, B₁₀Cl₁₀⁻, C₄BO₈⁻, B(C₂O₄)₂⁻, and CH₃SO₃⁻.

The ionomer may a cationic conductor having a cation exchange group such as a proton, or may be an anionic conductor having an anion exchange group such as hydroxy ions, carbonate, or bicarbonate.

The cation exchange group may be any one selected from the group consisting of a sulfonic acid group, a carboxyl group, a boron group, a phosphoric acid group, an imide group, a sulfonic imide group, a sulfonic amide group, and a combination thereof, and may generally be a sulfonic acid group or a carboxyl group.

The cation conductor may include the cation exchange group described above, and may be a fluorine-based polymer including fluorine in a main chain thereof; a hydrocarbon-based polymer such as benzimidazole, polyamide, polyamideimide, polyimide, polyacetal, polyethylene, polypropylene, an acrylic resin, polyester, polysulfone, polyether, polyetherimide, polyester, polyethersulfone, polyetherimide, polycarbonate, polystyrene, polyphenylene sulfide, polyether ether ketone, polyether ketone, polyaryl ether sulfone, polyphosphazene or polyphenylquinoxalin; a partially fluorinated polymer such as a polystyrene-graft-ethylene tetrafluoroethylene copolymer or a polystyrene-graft-polytetrafluoroethylene copolymer; and sulphon imide.

Furthermore, the cationic conductor may be one in which H is replaced with Na, K, Li, Cs, or tetrabutyl ammonium in the cation exchange group at an end of a side chain. In the case of replacing H with Na in the cation exchange group at the end of the side chain, NaOH may be used to replace H, and in the case of replacing H with tetrabutylammonium, tetrabutylammonium hydroxide may be used to replace H, and K, Li or Cs may also be replaced using appropriate compounds. A substitution method is widely known in the art.

The anionic conductor is a polymer that may transfer anions such as hydroxy ions, carbonate, or bicarbonate, and the anionic conductor may be commercially available in the form of hydroxides or halides (generally chloride), and any anionic conductor commonly used in industrial water purification, metal separation, or carbon structure processes may be used.

As the anionic conductor, a polymer doped with a metal hydroxide may be generally used, and specifically, poly(ethersulfone), polystyrene, vinyl-based polymer, poly(vinylchloride), poly(vinylidenefluoride), poly(tetrafluoroethylene), poly(benzimidazole), or poly(ethyleneglycol), doped with a metal hydroxide, may be used as the anion conductor.

In an advantageous embodiment, the salt may be a metal salt, more advantageously a metal salt containing a sulfonyl group, and in this case, the metal ion of the metal salt may be a metal ion (active ion) involved in an electrochemical reaction. The salt may induce effective complexation of a carbon-based conductive material and an organic binder, and may be included in at least one of the network configuration and the electrode material in a final electrode state or remain surface-adsorbed, and may remain as a salt-specific crystalline phase. In a case in which the salt is a metal salt, when the metal salt remaining in the electrode comes into contact with an electrolyte, the metal salt may be dissolved in the electrolyte and the concentration of the salt (active ion) in the electrolyte may be increased. Furthermore, together therewith or independently thereof, when the metal salt is a metal salt containing a sulfonyl group, the metal salt may remain in the electrode to improve the electrochemical properties of the electrode, thereby improving flame resistance of the electrode, and improving wettability to a liquid electrolyte.

A sulfonyl group-containing metal salt may have a molecular weight (g/mole) of 1000 or less, specifically 500 or less, and more specifically 400 or less, and may have a molecular weight of substantially 10 or more, 20 or more, or 30 or more. Furthermore, the sulfonyl group-containing metal salt may have 1 to 4 anions per molecule of the metal salt, and may have, specifically 1 to 3 anions, and more specifically 1 to 2 anions.

In an embodiment, a sulfonyl group-containing crystalline metal salt may be any one or two or more selected from compounds satisfying the following Chemical Formulae 1 to 4.

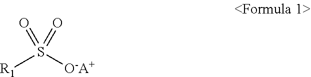

In Formula 1, A⁺ is a monovalent cation, R₁ is F, CFH₂, CF₂H or CₙF₂ₙ₊₁, where n is a natural number of 1 or more, specifically a natural number of 1 to 5, and more specifically a natural number of 1 to 3.

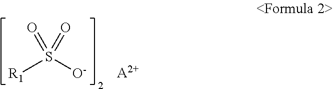

In Formula 2, A²⁺ is a divalent cation, R₁ is F, CFH₂, CF₂H or CₙF₂ₙ₊₁, where n is a natural number of 1 or more, specifically a natural number of 1 to 5, and more specifically a natural number of 1 to 3.

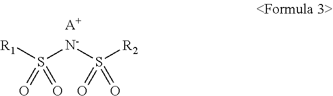

In Formula 3, A⁺ is a monovalent cation, and R₁ and R₂ are independent of each other and are F, CFH₂, CF₂H or CₙF₂ₙ₊₁, where n is a natural number of 1 or more, specifically a natural number of 1 to 5, and more specifically a natural number of 1 to 3.

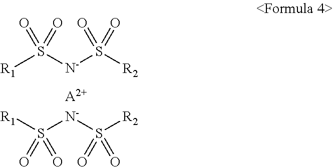

In Formula 4, A²⁺ is a divalent cation, and R₁ and R₂ are independent of each other, and are F, CFH₂, CF₂H, or CₙF₂ₙ₊₁, where n is a natural number of 1 or more, specifically a natural number of 1 to 5, and more specifically a natural number of 1 to 3.

In Formulas 1 to 4, A⁺ or A²⁺ may be a monovalent metal ion or a divalent metal ion capable of functioning as a counter part of a sulfonyl group-containing anionic component. As a non-limiting example, a monovalent cation may be an ion of a metal selected from at least one alkali metal and may be, for example, a lithium ion or a sodium ion, and a divalent cation may be an ion of at least one metal selected from an alkaline earth metal and a post-transition metal, and may be, for example, a zinc ion, or the like, but the present disclosure is not necessarily limited thereto. Together therewith or independently thereof, in Formulae 1 to 4, R₁ and R₂ may be each independently selected from F, CF₃, and CF₂CF₃. In a substantial embodiment, the sulfonyl group-containing metal salt may be any one or two or more selected from lithium trifluoromethanesulfonate, lithium bis(fluorosulfonyl)imide, lithium bis(trifluoromethanesulfonyl)imide, lithium bis(perfluoroethanesulfonyl)imide, zinc trifluoromethanesulfonate, zinc die [bis(trifluoromethylsulfonyl)imide], and the like.

In an embodiment, the at least two solvents may be at least two selected from the group consisting of water, an alcohol solvent, a ketone solvent, a carbonate solvent, an ester-based solvent, an ether-based solvent, a ketone-based solvent, and an amide-based solvent, and may be two or more types of solvent satisfying the above-described solubility parameter specification condition.

A specific example of the two or more types of solvent may include water, ethylene carbonate, propylene carbonate, 1,2-butylene carbonate, 2,3-butylene carbonate, 1,2-Pentylene carbonate, 2,3-Pentylene carbonate, vinylene carbonate, vinylethylene carbonate, fluoroethylene carbonate, dimethyl carbonate, diethyl carbonate, di(2,2-trifluoroethyl) carbonate, dipropyl carbonate, dibutyl carbonate, ethyl methyl carbonate, 2, 2,2-trifluoroethyl methyl carbonate, methylpropyl carbonate, Ethylpropyl carbonate, 2, 2,2-trifluoroethyl propyl carbonate, methyl isopropyl carbonate, methyl formate, ethyl formate, propyl formate, butyl formate, dimethyl ether, diethyl ether, dipropyl ether, methyl ethyl ether, methylpropyl ether, ethylpropyl ether, methyl acetate, ethyl acetate, propyl acetate, butyl acetate, methyl propionate, ethyl propionate, propyl propionate, butyl propionate, methyl butyrate, ethyl butyrate, propyl butyrate, butyl butyrate, γ-butyrolactone, 2-methyl-γ-butyrolactone, 3-methyl-γ-butyrolactone, 4-methyl-γ-butyrolactone, γ-thiobutyrolactone, γ-ethyl-γ-butyrolactone, β-methyl-γ-butyrolactone, γ-valerolactone, σ-valerolactone, γ-caprolactone, ε-caprolactone, β-propiolactone, tetrahydrofuran, 2-methyl tetrahydrofuran, 3-Methyltetrahydrofuran, trimethyl phosphate, triethyl phosphate, tris(2-chloroethyl)phosphate, tris(2,2-trifluoroethyl)phosphate, tripropyl phosphate, triisopropyl phosphate, tributyl phosphate, trihexyl phosphate, triphenyl phosphate, tritolyl phosphate, methyl ethylene phosphate, ethyl ethylene phosphate, dimethyl sulfone, ethyl methyl sulfone, methyl trifluoromethyl sulfone, ethyl trifluoromethyl sulfone, methyl pentafluoroethyl sulfone, ethyl pentafluoroethyl sulfone, di(trifluoromethyl) sulfone, di(pentafluoroethyl) sulfone, trifluoromethyl trifluoromethyl pentafluoroethylsulfone, nonafluorobutylsulfone, pentafluoroethyl nonafluorobutyl sulfone, sulfolane, 3-methylsulfolane, 2-methylsulfolane, 3-ethylsulfolane, 2-ethylsulfolane, methanol, ethanol, isopropyl alcohol N, N-dimethylformamide, N, N-dimethylacetamide, N-methyl-2-pyrrolidone, N-methylcaprolactam and tetramethylurea, and the like, but the present disclosure is not limited thereto.

The organic binder may be any polymer binder commonly used in the electrode field, and may be either an aqueous polymer binder or a non-aqueous polymer binder. Specifically, the polymer binder may be a fluorine-based resin, a rubber-based material, a polyolefin-based resin, an acrylic-based resin, an imide-based resin, a cellulose-based resin, or the like. Substantial examples of the polymeric binder may include polyvinylidene fluoride, polytetrafluoroethylene, polyvinylidene fluoride-hexafluoropropylene, polyvinylpyrrolidone, polyacrylonitrile, polyvinylidene fluoride-trichloroethylene, polyvinylidene fluoride-chlorotrifluoroethylene, polymethylmethacrylate, polyvinyl acetate, ethylene-co-vinyl acetate copolymer, polyethylene oxide, cellulose acetate, cellulose acetate butylate, cellulose acetate propionate, cyanoethyl pullulan, cyanoethyl polyvinyl alcohol, cyanoethyl cellulose, cyanoethyl sucrose, pullulan, carboxyl methyl cellulose, acrylonitrile styrene butadiene copolymer, polyimide, polyvinyl alcohol, carboxymethyl cellulose, starch, hydroxypropyl cellulose, recycled cellulose, polyvinylpyrrolidone, tetrafluoroethylene, polyethylene, polypropylene, ethylene-propylene-diene ter polymer (EPDM), sulfonated EPDM, styrene butadiene rubber, fluorine rubber, or mixtures thereof, but the present disclosure is not limited thereto.

In an embodiment, the electrode material may be a positive electrode material or a negative electrode material. The electrode material may be any material commonly used as an active material in a positive electrode or a negative electrode of the corresponding electrochemical cell in consideration a specific of electrochemical cell. Specifically, the electrode material may include a graphite-based material, a metal, a metal-nonmetal composite, a metalloid, a metalloid-nonmetal composite, a metalloid-metal composite, a metalloid-metal-nonmetal composite, or a mixture thereof. In this case, the metal may include one or more elements selected from at least alkali metals or one or more elements selected from alkali metals and transition metals, respectively, the metalloid may include one or more elements selected from silicon and germanium, the non-metal may include one or more elements selected from at least oxygen, nitrogen, phosphorus, sulfur, and selenium, and the composite may refer to an inter-element compound.

As an example of a lithium secondary battery, a positive electrode material may be used as long as the material may be capable of reversibly removal/insertion of lithium ions, and the positive electrode material may be LiMO₂ (M is one or two or more transition metals selected from Co and Ni); LiMO₂ (M is one or two or more transition metals selected from Co and Ni) replaced with one or two or more heterogeneous elements selected from Mg, Al, Fe, Ni, Cr, Zr, Ce, Ti, B, and Mn, or coated with an oxide of these heterogeneous elements; a layered oxide represented by LiₓNi_{α}Co_{β}M_{γ}O₂ (a real number of 0.8$x$1.5, a real number of 0.7≤α≤0.9, a real number of 0.05≤β≤0.35, a real number of 0.01≤, ≤0.1, α+β+γ=1, where M is one or more elements selected from the group consisting of Mg, Sr, Ti, Zr, V, Nb, Ta, Mo, W, B, Al, Fe, Cr, Mn and Ce), or LiₓNiₐMn_{b}Co_{c}M_{d}O₂ (a real number of 0.9≤x≤1.1, a real number of 0.3≤a≤0.6, a real number of 0.3≤b≤0.4, a real number of 0.1≤c≤0.4, a real number of 0≤d≤0.4, a+b+c+d=1, where M is one or more elements selected from Mg, Sr, Ti, Zr, V, Nb, Ta, Mo, W, B, Al, Fe, Cr and Ce); a spinel-structured oxide represented by LiₐMn₂₋ₓ MₓO₄ (where M is one or two or more elements selected from Al, Co, Ni, Cr, Fe, Zn, Mg, B and Ti, a real number of 1≤a≤1.1 and a real number of 0≤x≤0.2) or Li₄Mn₅O₁₂; or a phosphate-based material with an olivine structure represented by LiMPO₄ (M is Fe, Co, and Mn), or a mixture thereof, but the present disclosure is limited thereto.

The negative electrode material may be used as long as the material may be normally used for a negative electrode of a lithium secondary battery, and a material capable of lithium intercalation may be sufficient. For example, the negative electrode material may be one or two or more materials selected from lithium (metal lithium), graphitizable carbon, non-graphitizable carbon, graphite, silicon, a Sn alloy, a Si alloy, a Sn oxide, a Si oxide, a Ti oxide, a Ni oxide, a Fe oxide (FeO), a lithium-titanium oxide (LiTiO₂ and Li₄Ti₅O₁₂), a mixture thereof, or a composite thereof, but the present disclosure is not limited thereto.

The electrode material may be in a particle form, and an average size (diameter) thereof may be 1 to 50 μm, specifically 5 to 30 μm, but the present disclosure is not limited thereto.

In an embodiment, the slurry may satisfy one or more conditions of 1 to 4 below.
1) 0.01 to 30 parts by weight, 0.05 to 20 parts by weight, 0.1 to 10 parts by weight, and 0.5 to 5 parts by weight of the organic binder based on 100 parts by weight of the electrode material;
2) 10 to 300 parts by weight, 50 to 250 parts by weight, 50 to 200 parts by weight, and 50 to 150 parts by weight of the mixed solvent based on 100 parts by weight of the electrode material;
3) The slurry further including a conductive material, and 0.01 to 30 parts by weight, 0.05 to 20 parts by weight, 0.1 to 10 parts by weight, and 0.5 to 5 parts by weight of the conductive material based on 100 parts by weight of the electrode material; and
4) The slurry further including salt, and 0.01 to 50 parts by weight, 0.05 to 30 parts by weight, 0.1 to 20 parts by weight, and 0.5 to 10 parts by weight based on 100 parts by weight of the electrode material.

In an embodiment, the electrode slurry may be an electrode slurry for an electrochemical cell. The electrochemical cell may be a primary battery or a secondary battery capable of electrochemical reaction. More specifically, examples of the electrochemical cell may include a lithium primary battery, a lithium secondary battery, a lithium-sulfur battery, a lithium-air battery, a sodium battery, an aluminum battery, a magnesium battery, a calcium cell, a zinc cell, a zinc-air cell, a sodium-air cell, an aluminum-air cell, a magnesium-air cell, a calcium-air cell, a super capacitor, a dye-sensitized solar cell, a fuel cell, a lead storage cell, a nickel cadmium cell, a nickel hydrogen storage cell, or an alkaline cell, but the present disclosure is not limited thereto.

The present disclosure includes a method of fabricating an electrode using the electrode slurry described above.

The method of fabricating an electrode according to the present disclosure includes an operation of applying the above-described electrode slurry on a current collector; and an operation of drying the applied slurry layer.

The current collector to which the slurry is applied may be sufficient as long as it is a conductive member commonly used for smooth collection, transfer, and supply of charges in a conventional electrochemical cell. Specifically, the current collector may be a conductive material such as graphite, graphene, titanium, copper, platinum, nickel, silver, gold, aluminum or carbon nano tubes, but the present disclosure is not limited thereto.

The application of the electrode slurry may be carried out by one or more methods selected from spin coating, roll coating, spray coating, dip coating, flow coating, doctor blade, dispensing, inkjet printing, offset printing, stencil printing, screen printing, pad printing, gravure printing, reverse gravure printing, gravure offset printing, flexography printing, stencil printing, imprinting, xerography, slot die coating, bar coating, roll-to-roll coating, and the like, but the present disclosure is not limited thereto.

After the slurry application is performed, an operation of applying energy to a slurry coating material (coated slurry layer) and performing drying may be further performed. The applied energy may be thermal energy, light energy, or heat and light energy, and the application of heat and light energy may include sequential application or simultaneous application. When light energy is applied, light may be near-infrared light, which is a heating wire.

Drying by energy application may be performed at a temperature below a boiling point of two or more solvents included in the slurry. However, the lowest boiling point, among the boiling points of two or more solvents, may be used as a reference temperature (Tr), and the drying may be performed at 0.3 Tᵣ to 0.7 Tᵣ, specifically 0.3 Tᵣ to 0.5 Tᵣ. This drying temperature is advantageous because a large amount of the solvent having a higher boiling point may stably remain in a coating film after all the solvents having a lower boiling point than during drying are substantially volatilized and removed.

As described above, the boiling point of the solvent, which is a good solvent for the organic binder, may have the lowest boiling point, among the solvents included in the mixed solvent. Accordingly, the good solvent may be volatilized and removed and a mixed phase of precipitated (solidified) organic binder and bad solvent remains, but this bad solvent may act as a pore forming agent making the organic binder porous. Then, as drying continues, the bad solvent may also be volatilized and removed, and a fine porous network configuration filling an empty space between the electrode materials, binding to the electrode material and including an organic binder may be generated.

Then, when necessary, an operation of annealing the dried slurry layer may be further performed, but the present disclosure is not limited by the presence or absence of annealing. The annealing may be performed to remove a small amount of solvent molecules that may remain or/or to further improve binding strength between an active material and microporous manganese. The annealing may be performed at 100 to 220° C., but the present disclosure is not limited thereto.

After drying or, before or after annealing which is optionally performed, a step of manufacturing an electrode by roll-pressing the dried slurry layer may be further performed. As is known, there may be problem in that during roll-pressing for fabricating an active material layer, a particulate electrode material may be broken, pores in the electrode may become uneven, and the pores may be become clogged or be reduced. However, the microporous network configuration filling the empty space between the electrode materials may enable a smooth flow between electrode materials, so that breakage of the electrode material may be effectively prevented even during roll pressing.

The present disclosure includes an electrode fabricated by the above-described fabricating method.

The present disclosure includes an electrochemical cell including the electrode fabricated by the above-described fabricating method.

An electrode according to an aspect of the present disclosure includes a current collector; and an electrode layer disposed on at least one surface of the current collector, and the electrode layer includes a network configuration containing at least an organic binder, and an electrode material dispersed in the network configuration. In other words, the electrode layer may include a network-structured matrix filling an empty space between a particulate electrode material and a particulate electrode material and containing at least an organic binder.

The network configuration may be a porous structure in which fibrous phases containing an organic binder are irregularly entangled. In this case, the fibrous phase may have a shape such as a strip in which fibers are pressed, and when the strip-shaped fibrous phases are provided in plural form, the network configuration may also be collectively referred to as a porous foam structure. Specifically, the network configuration may have a specific surface area of 0.1 m²/g to 1,000 m²/g.

The electrode layer may further include a conductive material, and the conductive material may be complexed with an organic binder to form a network configuration. That is, the network configuration may be a porous structure in which fibrous phases including the organic binder and the conductive material are irregularly entangled.

When the network configuration includes a conductive material, the network configuration may be a conductive network configuration, in the electrode layer, the transfer, supply, and collection of charges may occur due to the electrical conductivity provided by the network configuration. Specifically, the electrical conductivity of the network configuration may be 0.01 S/cm to 1,000 S/cm.

However, due to the advantage of the electrode according to an embodiment of the present disclosure, in which sufficient electrical conductivity is secured in an electrochemical reaction without using a conductive material other than the network configuration, a separate conductive material may not be used, and the present invention does not exclude conductive materials that are not included in the network configuration and are provided separately from the network configuration.

Furthermore, the electrode may further include salt. The salt effectively induces complexation between the conductive material and the organic binder, as described above. The salt may be included in at least one of the network configuration and the electrode material or may be in a surface-adsorbed state. Specifically, the salt may be included in a fiber phase forming the network configuration and may be adsorbed and disposed on a surface thereof, and may also be adsorbed and disposed on a surface of the particulate electrode material.

In an embodiment, the electrode layer may have 0.01 to 40 parts by weight of a network configuration based on 100 parts by weight of the electrode material, and may specifically include 0.05 to 20 parts by weight, 0.1 to 10 parts by weight, and 0.5 to 5 parts by weight of the network configuration. When the network configuration is a conductive network configuration, the network configuration of 0.5 to 5 parts by weight denotes that a combined mass of the organic binder and the conductive material is 0.5 to 5 parts by weight based on 100 parts by weight of the electrode material. In the electrode according to an embodiment, the organic binder and the conductive material are combined to form a network configuration in an empty space between particulate electrode materials, and due to the electrode structure in which the particulate electrode materials are bound to the network configuration, even such a very small amount of organic binders and conductive materials may exhibit excellent electrochemical characteristics.

In an embodiment, when the electrode further includes a conductive material, the electrode may include 10 to 300 parts by weight, 30 to 200 parts by weight, and 50 to 150 parts by weight of the conductive material based on 100 parts by weight of the organic binder. In this case, when the network configuration is a conductive network configuration, the network configuration may include 10 to 300 parts by weight, 30 to 200 parts by weight, and 50 to 150 parts by weight of the conductive material based on 100 parts by weight of the organic binder.

In an embodiment, when the electrode further contains salt, the electrode may contain 0.01 to 50 parts by weight, 0.05 to 30 parts by weight, 0.1 to 20 parts by weight, 0.5 to 10 parts by weight, 0.5 to 5 parts by weight, and 0.5 to 3 parts by weight of the salt based on 100 parts by weight of the electrode material.

In the electrode according to an embodiment, an organic binder and a conductive material may be combined to form a network configuration in an empty space between particulate electrode materials, and the particulate electrode materials may be bound to the network configuration, and accordingly, even if a thickness of the electrode layer is as thick as 10³ μm, even uniform and stable electrical conductivity may be ensured, and at the same time, the electrolyte may be uniformly filled through the network configuration, and ion conduction may be easily generated, thereby remarkably suppressing degradation of the characteristics during thick film formation.

Accordingly, in the electrode according to an embodiment, the thickness of the electrode layer may be 1 μm to 2000 μm, and may be a thick film-type electrode having a thickness of 50 to 2000 μm, in which characteristics thereof are degraded due to an increase in thickness.

According to the technical features of the present disclosure described above, the electrode according to another aspect of the present disclosure is a thick film-type electrode, and the thick film-type electrode may include a current collector; and an electrode layer disposed on at least one surface of the current collector, and the electrode layer may include a network configuration including an organic binder and a conductive material, and an electrode material dispersed in the network configuration, and a thickness of the electrode layer may be 50 to 2000 μm, 100 to 1500 μm, 100 to 1000 μm, 200 to 1000 μm, or 300 to 1000 μm.

According to the technical features of the present disclosure described above, the electrode may have extremely excellent ion and electron transfer uniformity even under high-rate conditions, and accordingly, an electrode according to another aspect of the present disclosure may include a current collector; and an electrode layer disposed on at least one surface of the current collector, and the electrode layer may include a network configuration including an organic binder and a conductive material, and an electrode material dispersed in the network configuration, and may satisfy Equation 2 below.

$${η}_{a c t \& c o n c} / {η}_{o h m i c} \leq 0.8 \qquad < Equation 2 >$$

In Equation 1, η_{ohmic} represents ohmic polarization at 5C, and η_{act&conc} represents a sum of activation polarization and concentration polarization at 5C. Specifically, η_{act&conc}/η_{ohmic} may be 0.7 or less, 0.6 or less, 0.5 or less, 0.4 or less, or 0.3 or less, and may be substantially more than zero, or 0.1 or more.

In an embodiment, η_{act&conc}, which is the sum of activation polarization and concentration polarization at 5C, may be 90 mV or less, 80 mV or less, 70 mV or less, 60 mV or less, 50 mV or less, or 40 mV or less, and may be substantially 20 mV or more.

According to the technical features of the present disclosure described above, the electrode may have extremely excellent high-rate characteristics, and accordingly, an electrode according to another aspect of the present disclosure may include a current collector; and an electrode layer disposed on at least one surface of the current collector, and the electrode layer may include a network configuration including an organic binder and a conductive material, and an electrode material dispersed in the network configuration, and may satisfy Equation 1 below.

$$0.3 \leq C 5 / C 0.1 \qquad < Equation 1 >$$

In Equation 1, C0.1 represents discharge capacity at 0.1C, and C5 represents discharge capacity at 5C. Specifically, C5/C0.1 may be 0.4 or more, 0.5 or more, 0.6 or more, or 0.7 or more, and may be substantially 0.9 or less.

According to the technical features of the present disclosure described above, the electrode may be a porous electrode, and may be a composite electrode complexed with an electrolyte, specifically a solid electrolyte. Accordingly, an electrode according to another aspect of the present disclosure may be a composite electrode, and may include a current collector; and an electrode layer disposed on at least one surface of the current collector, and the electrode layer may include a network configuration including an organic binder, an electrode material, and a solid electrolyte.

In an embodiment, the solid electrolyte may include a gel-type solid electrolyte filling the empty space of the network configuration, and the electrode material may be dispersed and bound to a network configuration filled with the gel-type solid electrolyte. Furthermore, the conductive material may be complexed with an organic binder to form a network configuration. The network configuration in which voids thereof are filled with the gel-type solid electrolyte may be fabricated by fabricating the electrode according to the aforementioned method and then injecting a conventional gel-type solid electrolyte solution or a precursor solution into an electrode to fill an empty space (including an empty space of a network configuration) in the electrode and then gelling the solution, but the fabricating method is not necessarily limited by this manufacturing method.

In another embodiment, the solid electrolyte may be dispersed and bound to a network configuration including an organic binder together with an electrode material. The solid electrolyte may be particulate like the electrode material, and may be uniformly dispersed in the electrode layer, and may be an inorganic solid electrolyte, but the present disclosure is not limited thereto. The electrode including a particulate inorganic solid electrolyte may be fabricated by additionally adding an inorganic solid electrolyte to the electrode slurry described above to fabricate a composite electrode slurry, and applying and drying the composite electrode slurry and then roll pressing the same, but the fabricating method is not necessarily limited by this manufacturing method.

The electrode (composite electrode) complexed with the above-described solid electrolyte is more advantageous for an all-solid-state electrochemical cell electrode.

The present disclosure includes an electrochemical cell including the above-described electrode. The above-described electrode provided in the electrochemical cell may be a positive electrode or a negative electrode, and each of the positive electrode and the negative electrode may be an electrode according to an aspect of the present disclosure.

The electrochemical cell may include a positive electrode, a negative electrode, a separator interposed between the positive electrode and the negative electrode, and a liquid electrolyte, and may include a positive electrode, a negative electrode, and a solid electrolyte layer interposed between the positive electrode and the negative electrode. The separator, the liquid electrolyte, and the solid electrolyte layer may all be sufficient as long as they may have the materials and structures commonly known in a corresponding electrochemical cell in consideration of a specific electrochemical cell. The electrochemical cell may be a primary battery or a secondary battery capable of electrochemical reaction. For example, the electrochemical cell may be a lithium primary battery, a lithium secondary battery, a lithium-sulfur battery, a lithium-air battery, a sodium battery, an aluminum battery, a magnesium battery, a calcium battery, a zinc battery, a zinc-air cell, a sodium-air cell, an aluminum-air cell, a magnesium-air cell, a calcium-air cell, a supercapacitor, a dye-sensitized solar cell, a fuel cell, a lead storage cell, a nickel cadmium cell, a nickel hydrogen storage cell, or an alkaline cell, but the present disclosure is not limited thereto.

The electrochemical cell described above is referred to as a unit cell, and the present disclosure includes an electrochemical module in which two or more cells are arranged and electrically connected to each other. The electrochemical module may have an arrangement and structure of cells commonly used in the field of electrochemical devices, and the electrochemical module may have an arrangement and a structure of cells commonly used in the field of electrochemical devices, and may further include a typical cooling member such as a cooling plate or the like.

The present disclosure includes a device supplied with power by the electrochemical cell or the electrochemical module described above. For example, the device may be a device requiring large-sized power, such as an electric vehicle or a hybrid vehicle, but the present disclosure is not limited thereto.

### Inventive Example 1

Positive Electrode Fabrication: An electrode slurry was fabricated by preparing, as an electrode material,94 parts by weight of a lithium-nickel-manganese-cobalt composite oxide (LiNi_{0.6}CO_{0.2}Mn_{0.2}O₂) having an average particle diameter of 5 μm as a positive electrode active material, 3 parts by weight of Super-P having an average particle diameter of 40 nm as a conductive material, 3 parts by weight of polyvinylidene fluoride as a binder, and adding the electrode material to a mixed solvent so that a content of the electrode material is 55 wt %, using the mixed solvent in which 37.5 parts by weight of N-methyl-2-pyrrolidone and 7.5 parts by weight of propylene carbonate are mixed.

The electrode slurry was applied to an aluminum thin film having a thickness of 20 μm using a doctor blade, hot air dried at 100° C., and then, was vacuum-dried at 130° C. for 24 hours and rolled with a roll press, thus preparing a positive electrode coated with an active material layer having a thickness of 70 μm.

### Inventive Example 2

Positive Electrode Fabrication: An electrode slurry was fabricated by preparing, as an electrode material, 94 parts by weight of a lithium-nickel-manganese-cobalt composite oxide (LiNi_{0.6}CO_{0.2}Mn_{0.2}O₂) having an average particle diameter of 5 μm as a positive electrode active material, 3 parts by weight of Super-P having an average particle diameter of 40 nm as a conductive material, 3 parts by weight of polyvinylidene fluoride as a binder and 1.5 parts by weight of lithium trifluoromethanesulfonate as salt, and adding the electrode material to a mixed solvent so that a content of the electrode material is 55 wt %, using the mixed solvent in which 37.5 parts by weight of N-methyl-2-pyrrolidone and 7.5 parts by weight of propylene carbonate are mixed.

The electrode slurry was applied to an aluminum thin film having a thickness of 20 μm using a doctor blade, hot air dried at 100° C., and then, was vacuum-dried at 130° C. for 24 hours and rolled with a roll press, thus preparing a positive electrode coated with an active material layer having a thickness of 70 μm.

### Inventive Example 3

Positive Electrode Fabrication: An electrode slurry was fabricated by preparing, as an electrode material, 99 parts by weight of a lithium-nickel-manganese-cobalt composite oxide (LiNi_{0.6}CO_{0.2}Mn_{0.2}O₂) having an average particle diameter of 5 μm as a positive electrode active material, 0.5 parts by weight of Super-P having an average particle diameter of 40 nm as a conductive material, 0.5 parts by weight of polyvinylidene fluoride as a binder and 1.5 parts by weight of lithium trifluoromethanesulfonate as salt, and adding the electrode material to a mixed solvent so that a content of the electrode material is 85 wt %, using the mixed solvent in which 37.5 parts by weight of N-methyl-2-pyrrolidone and 7.5 parts by weight of propylene carbonate are mixed.

The electrode slurry was applied to an aluminum thin film having a thickness of 20 μm using a doctor blade, hot air dried at 100° C., and then, was vacuum-dried at 130° C. for 24 hours and rolled with a roll press, thus preparing a positive electrode coated with an active material layer having a thickness of 70 μm.

### Inventive Example 4

Negative Electrode Fabrication: A negative electrode active material composition was fabricated by preparing, as an electrode material, 97.3 parts by weight of natural graphite powder particles as a negative electrode active material, 0.1 parts by weight of Super-P having an average particle diameter of 40 nm as a conductive material, 1.3 wt % of styrene-butadiene rubber as a binder, 1.3 parts by weight of carboxymethyl cellulose and 1.5 parts by weight of lithium trifluoromethanesulfonate as salt, and utilizing a fixed solvent in which 95 parts by weight of distilled water and 5 parts by weight of propylene carbonate are mixed. The negative electrode active material composition is applied to a copper thin film having a thickness of 20 μm using a doctor blade, dried at 120° C., and then, was roll pressed using a roll press, thus preparing a negative electrode coated with an active material layer having a thickness of 65 μm.

### Evaluation Example

Secondary Battery Fabrication: A battery assembly was fabricated by utilizing the fabricated positive electrode and the fabricated negative electrode as counter electrodes, respectively, and stacking a separator (polyethylene having a thinness of 15 μm), and then, after the battery assembly was sealed in a battery case, a liquid electrolyte in which 1 mol of LiPF₆ was dissolved into a solvent in which ethylene carbonate and dimethyl carbonate were mixed in a volume ratio of 1:1 was injected thereinto, thus fabricating a battery.

### Comparative Example 1

A secondary battery was fabricated in the same manner as Inventive Example, except that upon fabricating a positive electrode, a slurry was fabricated by preparing, as an electrode material, 94 parts by weight of a lithium-nickel-manganese-cobalt composite oxide (LiNi_{0.6}Co_{0.2}Mn_{0.2}O₂) having an average particle diameter of 5 μm as a positive electrode active material, 3 parts by weight of Super-P having an average particle diameter of 40 nm as a conductive material and 3 parts by weight of polyvinylidene fluoride as a binder, and mixing the electrode material with a single solvent of N-methyl-2-pyrrolidone.

### Comparative Example 2

Upon fabricating a positive electrode, a slurry was fabricated by preparing, as an electrode material, 99 parts by weight of a lithium-nickel-manganese-cobalt composite oxide (LiNi_{0.6}Co_{0.2}Mn_{0.2}O₂) having an average particle diameter of 5 μm as a positive electrode active material, 0.5 parts by weight of Super-P having an average particle diameter of 40 nm as a conductive material and 0.5 parts by weight of polyvinylidene fluoride as a binder, and mixing the electrode material with a single solvent of N-methyl-2-pyrrolidone.

When the electrode slurry was applied to an aluminum thin film having a thickness of 20 μm using a doctor blade, hot air dried at 100° C., and then was vacuum-dried at 130° C. for 24 hours and rolled with a roll press, it was observed that the electrode layer was peeled off on a positive electrode current collector.

### Comparative Example 3

A secondary battery was fabricated in the same manner as Inventive Example, except that upon fabricating a negative electrode, a slurry was fabricated by preparing, as an electrode material, 97.3 parts by weight of natural graphite powder particles, 0.1 parts by weight of Super-P having an average particle diameter of 40 nm as a conductive material, 1.3 wt % of styrene-butadiene rubber as a binder and 1.3 parts by weight of carboxymethylcellulose, and mixing the electrode material with a single distilled water solvent.

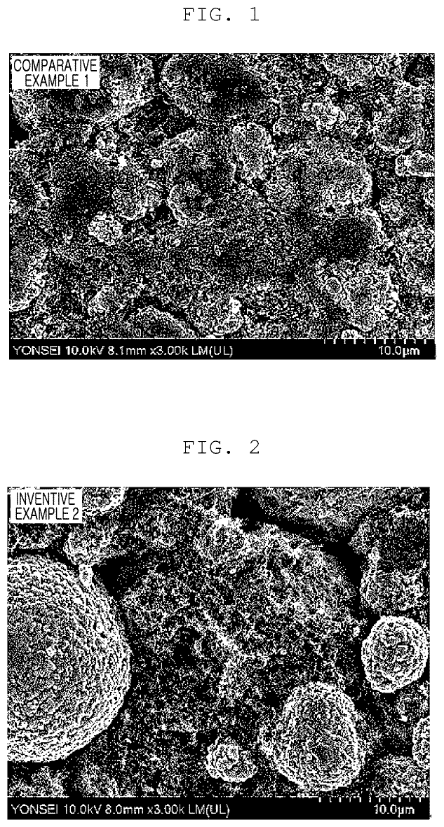

FIG. 1 is a scanning electron micrograph image obtained by observing a structure of a positive electrode fabricated in Comparative Example 1. As illustrated in FIG. 1, it may be seen that a positive electrode active material is broken, binders are aggregated, and the positive electrode has a non-uniform microstructure and a pore distribution.

FIG. 2 is a scanning electron microscope photograph showing a structure of the positive electrode prepared in Example 2. As illustrated in FIG. 2, in the case of the positive electrode fabricated in Inventive Example 2, it may be seen that an empty space between positive electrode active material particles is filled with a network configuration in which fiber phases were randomly entangled, and it may be seen that even though the rolling was performed in the same manner as Comparative Example 1 in fabricating the positive electrode, the positive electrode active material was not broken, and the shape of raw material powder particles added during the fabricating of the slurry was substantially maintained. The electrodes prepared in Inventive Examples 1, 3, and 4 were also observed to have a network configuration similar to that of the electrode fabricated in Inventive Example 2.

FIG. 3 is a view illustrating peel strength of a positive electrode active material layer fabricated in Inventive Example 2 and Comparative Example 1, and although the binder was porous, it may be seen that the peel strength was improved by a porous membrane structure uniformly filling an empty space between particles of a positive electrode active material.

Table 1 shows the measurement of battery capacity at 0.1C/0.1C charge/discharge conditions in secondary batteries equipped with the positive electrodes manufactured in Inventive Example 2 and Comparative Example 1, and as illustrated in Table 1, it may be seen that a carbon-based conductive material is complexed with the binder and forms a porous network structure, but exhibits normal charging and discharging behavior that is substantially equivalent to that of a reference battery manufactured in Comparative Example.

TABLE 1

| | Charging | Discharge | |
|---|---|---|---|
| | Capacity (mAh) | Capacity (mAh) | Efficiency (%) |
| Inventive | 53.778 | 47.102 | 87.59 |
| Example 2 | | | |
| Comparative | 54.952 | 48.556 | 88.36 |
| Example 1 | | | |

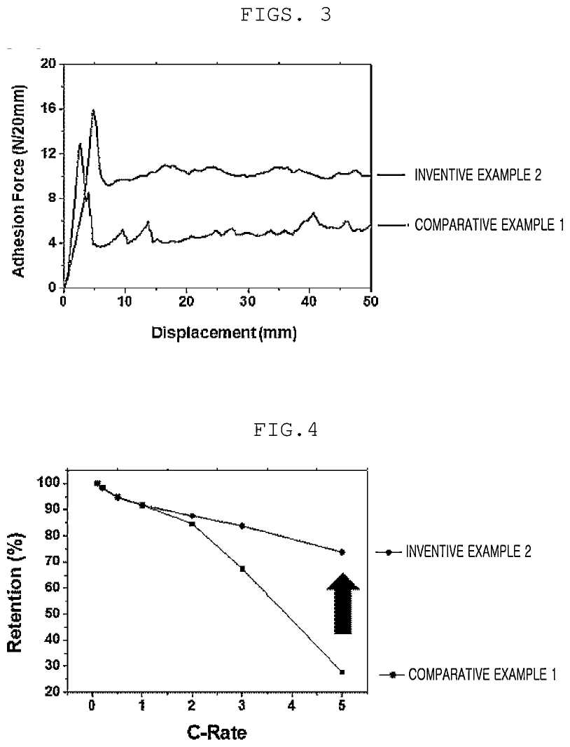

FIG. 4 is a view illustrating results of measuring a discharge capacity retention rate according to a C-rate, and it may be seen that a positive electrode fabricated in Inventive Example 2 had remarkably excellent high rate characteristics as compared to Comparative Example 1.

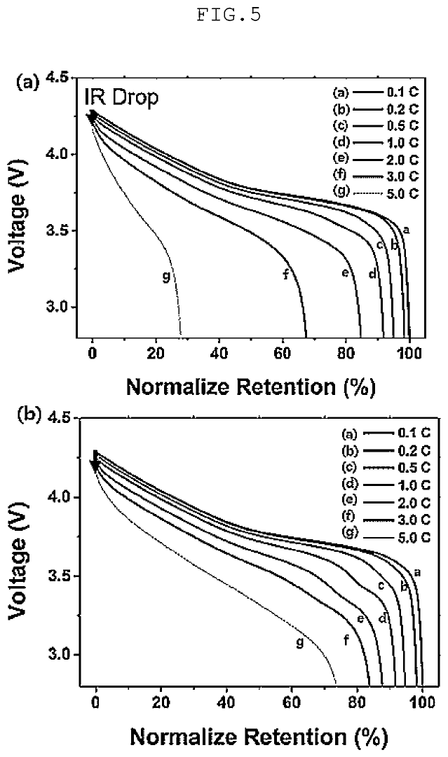

FIG. 5 is a view illustrating discharge characteristics of for each C-rate of a positive electrode fabricated in Comparative Example 1 (FIG. 5A) and a positive electrode fabricated in Inventive Example 2 (FIG. 5B), and as may be seen in FIG. 5, in the case of the positive electrode fabricated in Inventive Example, an IR drop (ohmic polarization) is larger than that of the positive electrode of Comparative Example, but the activation polarization is significantly improved and the capacity is superior to that of Comparative Example.

As described above, the present disclosure has been described with specific matters and limited embodiments and drawings, but this is provided to help a general understanding of the present disclosure, and the present invention is not limited to the aforementioned embodiments, and a person skilled in the art to which the present disclosure pertains may make various changes and modifications.

Accordingly, the concept of the present disclosure should not be limited to the described embodiments, and it will be understood that not only the claims to be described below, but also all those that have equivalent modifications to the claims belong to the scope of the present disclosure.

1. An electrode slurry comprising:
an electrode material;
an organic binder; and
a mixed solvent including two or more solvents having different solubility parameters.

2. The electrode slurry of claim 1, wherein the two or more solvents have different boiling points.

3. The electrode slurry of claim 1, wherein the slurry further comprises a conductive material.

4. The electrode slurry of claim 1, wherein the slurry further comprises salt.

5. The electrode slurry of claim 1, wherein the mixed solvent comprises the two or more solvents having a solubility parameter difference of 0.1 to 20.

6-8. (canceled)

9. The electrode slurry of claim 1, wherein the slurry satisfies one or more of the following conditions 1 to 4:
1) 0.01 to 30 parts by weight of the organic binder based on 100 parts by weight of the electrode material;
2) 10 to 300 parts by weight of the mixed solvent based on 100 parts by weight of the electrode material;
3) the slurry further comprising a conductive material, and 0.01 to 30 parts by weight of the conductive material based on 100 parts by weight of the electrode material; and
4) the slurry further comprising salt, and 0.01 to 50 parts by weight of salt based on 100 parts by weight of the electrode material.

10. (canceled)

11. The electrode slurry of claim 4, wherein the salt comprises a metal salt, an ionic liquid, an ionomer, or a mixture thereof.

12. The electrode slurry of claim 11, wherein the metal salt comprises a sulfonyl group.

13-16. (canceled)

17. An electrode comprising:
a current collector;
an electrode layer disposed on at least one surface of the current collector,
wherein the electrode layer comprises:
a network configuration including at least an organic binder; and
an electrode material dispersed in the network configuration.

18. The electrode of claim 17, wherein the electrode layer further comprises a conductive material.

19. (canceled)

20. The electrode of claim 18, wherein the conductive material is complexed with the organic binder to form the network configuration.

21. The electrode of claim 17, wherein a specific surface area of the network configuration is 0.1 m²/g to 1,000 m²/g.

22. The electrode of claim 17, wherein the electrode layer contains 0.01 to 40 parts by weight of the network configuration based on 100 parts by weight of the electrode material.

23. (canceled)

24. The electrode of claim 20, wherein the network configuration has an electrical conductivity of 0.01 S/cm to 1,000 S/cm.

25. The electrode of claim 17, wherein the electrode further contains salt.

26. The electrode of claim 25, wherein the salt is contained in or surface-adsorbed on at least one of the network configuration and the electrode material.

27. (canceled)

28. The electrode of claim 17,
wherein the electrode satisfies Equation 2 below,
$${η}_{a c t \& c o n c} / {η}_{o h m i c} \leq 0.8 \qquad < Equation 2 >$$
where η_{ohmic} is ohmic polarization at 5C, and η_{act&conc} is the sum of activation polarization and concentration polarization at 5C.

29. The electrode of claim 28, wherein η_{act&conc}, which is the sum of the activation polarization and the concentration polarization at 5C, is 90 mV or less.

30. (canceled)

31. (canceled)

32. The electrode of claim 17,
wherein the electrode layer has a thick film type with a thickness of 50 to 3000 μm.

33. The electrode of claim 17,
wherein the electrode layer further contains solid electrolyte.

34-36. (canceled)
